(19) United States
(12) Patent Application Publication
(10) Pub. No.: US 2015/0058452 A1
(43) Pub. Date: Feb. 26, 2015

(54) VIDEO LOADING METHOD, DEVICE AND SYSTEM OF MOBILE TERMINAL

(71) Applicant: Tencent Technology (Shenzhen) Company Limited, Shenzhen (CN)

(72) Inventors: Jing Liu, Shenzhen (CN); Xiaodan Lin, Shenzhen (CN)

(21) Appl. No.: 14/528,752

(22) Filed: Oct. 30, 2014

Related U.S. Application Data
(63) Continuation of application No. PCT/CN2013/088787, filed on Dec. 6, 2013.

(30) Foreign Application Priority Data
Apr. 9, 2013 (CN) CN 201310121340.5

(51) Int. Cl. H04L 29/06; H04L 29/08

(52) U.S. Cl. CPC H04L 65/60; H04L 67/10
USPC 709/219

(57) ABSTRACT

The disclosure is suitable for the mobile Internet field, and provides a video loading method, device and system of mobile terminal, comprising: acquiring a video resource address in a web page by a browser client; acquiring a platform ID code of the mobile terminal identifying a software platform of the mobile terminal by the browser client; transmitting a video loading request to a browser server by the browser client, so that the browser server delivers to the browser client a video corresponding to the video resource address and conforming to a video playback format of the software platform of the mobile terminal; and loading, by the browser client, the video. When the browser server is centrally exhibiting video resources to the browser client based on the scheme, the browser client can successively request, from a video content server, a video suitable for the software platform of the mobile terminal.

### CROSS-REFERENCES TO RELATED APPLICATIONS

This application is a continuation of International Application No. PCT/CN2013/088787, filed on Dec. 6, 2013, which claims priority to Chinese patent application No. 201310121340.5, filed on Apr. 9, 2013, the content of which are incorporated herein by reference in their entirety.

### TECHNICAL FIELD

The present application relates to the field of the mobile Internet, particularly to a video loading method, device and system of a mobile terminal.

### BACKGROUND

Based on the mobile Internet, a user can acquire information through a mobile terminal anytime anywhere, and with the diversified development of the mobile Internet service, the information mobile Internet information dissemination is no longer confined to texts, pictures, sounds and other forms of media, but also derive to the video media form, providing a user with a rich mobile Internet experience.

The mobile terminal accesses web pages through a Wireless Application Protocol (WAP) browser (hereinafter referred to as a browser). In order to give users a more optimal web experience, an existing browser will filter marketing information such as advertising and so on in each site at its back-end server, effectively refine and integrate the network resources in these sites, exhibit the refined and integrated resources on a particular page in different classes, and ultimately present them on a client interface of the browser as a preset page. For example, “news center” is exhibited on a start page after the mobile terminal starts the browser, the “news center” integrates main news links from various portal sites, and the user can browse news directly by clicking news links therein.

However, if the above-described way is adopted to integrate video resources in each site, when the mobile terminal clicks on the video link therein, it is required that the browser server requests from a video content server corresponding video resources and delivers them to the mobile terminal. At this time, the video content server is only possible to deliver to the browser server videos conforming to the playback formats of the browser server, resulting in that the format of the video received by the mobile terminal ultimately does not conform to the system type of the mobile terminal, and video loading and playback can not be realized, thereby reducing the ability of dissemination of the video resources in the mobile Internet.

### SUMMARY

An object of an embodiment of the present application is to provide a video loading method of a mobile terminal, solving the problem in the prior art that in case that a browser server centrally exhibits video resources in various sites, a browser client can not implement the loading and playback of videos, leading to reducing the ability of dissemination of the video resources in the mobile Internet.

The embodiment of the present application is achieved as follows. A video loading method of a mobile terminal comprises:

acquiring a video resource address in a web page by a browser client;

acquiring a platform ID code of the mobile terminal by the browser client, the platform ID code identifying a software platform of the mobile terminal;

transmitting to a browser server a video loading request including the video resource address and the platform ID code by the browser client, so that the browser server delivers to the browser client a video corresponding to the video resource address and conforming to a video playback format of the software platform of the mobile terminal; and

loading, by the browser client, the video delivered by the browser server.

Another object of the embodiment of the present application is to provide a video loading method of a mobile terminal, comprising:

acquiring, by a browser server, a video loading request sent by a browser client, the video loading request including a video resource address and a platform ID code of the mobile terminal, the platform ID code identifying a software platform of the mobile terminal;

forwarding, by the browser server, the video loading request to a video content server which the video resource address points to, so that the video content server returns to the browser server a video corresponding to the video resource address and conforming to a video playback format of the software platform of the mobile terminal; and

by the browser server, receiving the video returned by the video content server and delivering the video to the browser client, so that the browser client loads the video.

Another object of the embodiment of the present application is to provide a video loading method of a mobile terminal, comprising:

receiving, by a video content server, a video loading request forwarded by a browser server, the video loading request being sent by a browser client to the browser server and including a video resource address and a platform ID code of the mobile terminal, the platform ID code identifying a software platform of the mobile terminal;

determining a video playback format conforming to the software platform of the mobile terminal by the video content server based on the platform ID code;

extracting, by the video content server, a video of the video playback format conforming to the software platform of the mobile terminal from prestored videos of all video playback formats corresponding to the video resource address;

returning to the browser server the extracted video by the video content server, so that the browser server delivers the video to the browser client, and the browser client loads the video.

Another object of the embodiment of the present application is to provide a browser client, comprising:

a video resource address acquiring unit configured to acquire a video resource address from a web page;

a platform ID code acquiring unit configured to acquire a platform ID code of the mobile terminal, the platform ID code identifying a software platform of the mobile terminal;

a transmitting unit configured to transmit a video loading request including the video resource address and the platform ID code to a browser server, so that the browser server delivers to the browser client a video corresponding the video resource address and conforming to a video playback format of the mobile terminal; and

a loading unit configured to load the video delivered by the browser server.

Another object of the embodiment of the present application is to provide a browser server, comprising:

a request acquiring unit configured to acquire a video loading request sent by a browser client, the video loading request including a video resource address and a platform ID code of the mobile terminal, the platform ID code identifying a software platform of the mobile terminal;

a forwarding unit configured to forward the video loading request to a video content server which the video resource address points to, so that the video content server returns to the browser server a video corresponding to the video resource address and conforming to a video playback format of the software platform of the mobile terminal; and

a delivering unit configured to receive the video returned by the video content server and delivering the video to the browser client, so that the browser client loads the video.

Another object of the embodiment of the present application is to provide a video content server, comprising:

a request receiving unit configured to receive a video loading request forwarded by a browser server, the video loading request being sent by a browser client to the browser server and including a video resource address and a platform ID code of the mobile terminal, the platform ID code identifying a software platform of the mobile terminal;

a determining unit configured to determine a video playback format conforming to the software platform of the mobile terminal based on the platform ID code;

a extracting unit configured to extract a video of the video playback format conforming to the software platform of the mobile terminal from prestored videos of all video playback formats corresponding to the video resource address; and

a returning unit configured to return the extracted video to the browser server, so that the browser server delivers the video to the browser client, and the browser client loads the video.

Another object of the embodiment of the present application is to provide a video loading system of a mobile terminal, wherein the system comprises a browser client, a browser server and a video content server,

the browser client, including:

a video resource address acquiring unit configured to acquire a video resource address from a web page;

a platform ID code acquiring unit configured to acquire a platform ID code of the mobile terminal, the platform ID code identifying a software platform of the mobile terminal;

a transmitting unit configured to transmit a video loading request including the video resource address and the platform ID code to a browser server; and

a loading unit configured to load the video delivered by the browser server;

the browser server, including:

a request acquiring unit configured to acquire the video loading request sent by a browser client;

a forwarding unit configured to forward the video loading request to a video content server which the video resource address points to; and

a delivering unit configured to receive a video returned by the video content server and delivering the video to the browser client;

the video content server, including:

a request receiving unit configured to receive the video loading request forwarded by a browser server;

a determining unit configured to determine a video playback format conforming to the software platform of the mobile terminal based on the platform ID code;

a extracting unit configured to extract the video of the video playback format conforming to the software platform of the mobile terminal from prestored videos of all video playback formats corresponding to the video resource address; and

a returning unit configured to return the extracted video to the browser server.

The embodiment of the present application is based on a content providing scheme that a browser server centrally exhibits resources from various sites in a preset page of a browser client. With respect to the scheme, a video loading method of a mobile terminal is provided, so that when the browser server are exhibiting video resources to the browser client based on the scheme, the browser client can successively request, from a video content server through the browser server, a video suitable for the software platform of the mobile terminal it is located in, thereby increasing the ability of dissemination of the video resources in the mobile Internet.

### BRIEF DESCRIPTION OF THE DRAWINGS

FIG. 1 is a structural block diagram of a video loading system of a mobile terminal according to an embodiment of the present application;

FIG. 2 is an implementation flow diagram of a video loading method of a mobile terminal at a browser client according to the embodiment of the present application;

FIG. 3 is an implementation flow diagram of a video loading method of a mobile terminal at a browser server according to the embodiment of the present application;

FIG. 4 is an implementation flow diagram of a video loading method of a mobile terminal at a browser server according to another embodiment of the present application;

FIG. 5 is an implementation flow diagram of a video loading method of a mobile terminal at a video content server according to the embodiment of the present application;

FIG. 6 is an interactive flow diagram of a video loading method of a mobile terminal according to an embodiment of the present application; and

FIG. 7 is a device structural diagram of a video loading system of a mobile terminal according to an embodiment of the present application.

### DETAILED DESCRIPTION

In order to make the objects, solutions and advantages of the present application more clearly understandable, the present application will be further detailed below in conjunction with drawings and embodiments. It should be understood that the specific embodiments described herein are only used for explaining the present application, instead of limiting the present application.

An embodiment of the present application provides a content providing scheme based on browser server centrally exhibiting contents from resources of various sites in a preset page of a browser client. With respect to the scheme, a video loading method of a mobile terminal is provided, so that when the browser server are exhibiting video resources to the browser client based on the scheme, the browser client can successively request, from a video content server through the browser server, a video suitable for being played back by the software platform of the mobile terminal it is located in, thereby increasing the ability of dissemination of the video resources.

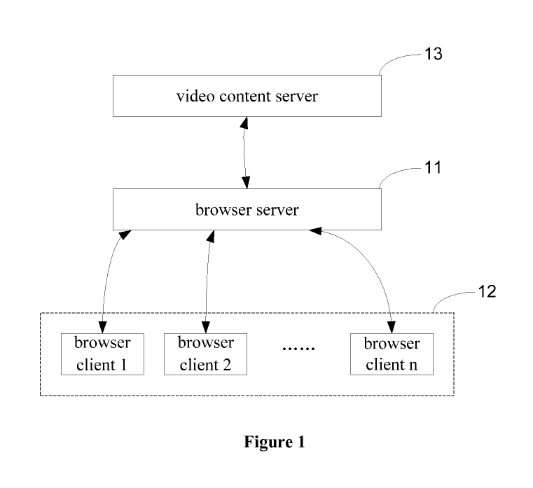

FIG. 1 shows a structural block diagram of a video loading system of a mobile terminal according to an embodiment of the present application. In order to facilitate illustration, only portions related to the present embodiment are shown.

Referring to FIG. 1, the system comprises a browser server 11, at least a browser client 12 corresponding to the browser server 11, and a video content server 13.

The browser server 11 is configured to extract and effectively integrate the video resources provided by various video content issuing sites on the mobile Internet, thus generating a centrally exhibiting page of the video resources, and the video resources exhibited in the page may come from various video content issuing sites in the mobile Internet. Meantime, the browser server 11 will synchronize the centrally exhibiting page of the video resources generated by it to its corresponding various browser client 12 through a network. The browser client 12 is configured to present the centrally exhibiting page to a user. For example, the centrally exhibiting page is presented in a start page when the browser client 12 starts. For another example, the centrally exhibiting page is presented in a built-in navigation page of the browser client 12.

The video content server 13 is a content issuer corresponding to a video resource exhibited in the centrally exhibiting page, and, as a network node, stores the video resource. When receiving a video resource request from a content requester, the video content server 13 may address to a specific storage location of the video resources in the video content server 13 based on the video resource address carried in the request, and transmit the video resource to corresponding content requester.

In the embodiment of the present application, the browser client 12 is for example a WAP browser which runs on a mobile terminal. Wherein the mobile terminal comprises, but is not limited to, such a smart mobile terminal apparatus having a mobile Internet access function as a mobile phone, a tablet computer and etc. The above mentioned mobile terminals all run the browser client 12 based on a specific software platform (for example, such software platforms as Android and IOS), and the video formats that can be played back on each kind of software platform are different. For example, the IOS software platform can only play back a video file of mov format, while the Android software can only play a video file of mpg format and can not play back a video file of mov format. Therefore, videos of video formats suitable for being played back by the present mobile terminal need to be delivered to the browser client 12 based on the software platform of the mobile terminal.

In the present embodiment, the video needed to be loaded to play back in the mobile terminal is requested by the browser client 12 to the corresponding video content server 13 through the browser server 11. The video loading process of the mobile terminal will be detailed below through a specific embodiment.

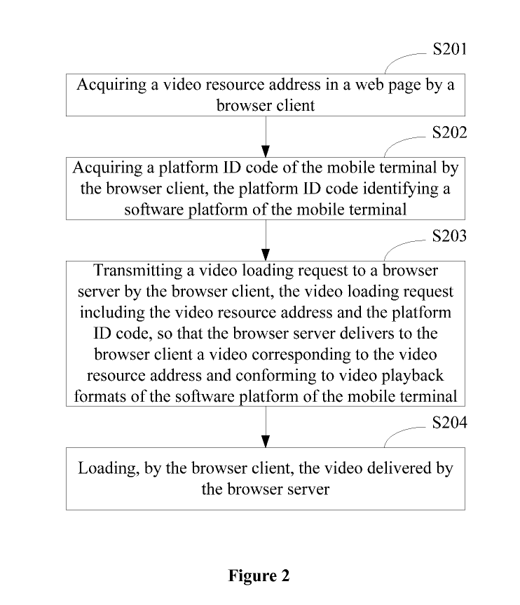

FIG. 2 shows an implementation flow diagram of a video loading method of a mobile terminal at a browser client according to the embodiment of the present application.

In step S201, a browser client acquires a video resource address in a web page.

In the present embodiment, the browser client acquires the video resource address of a video resource which a user wishes to load and play back in the mobile terminal by detecting such user events as clicking and touching in the currently accessed web page, wherein the form in which the video resource address exists can be a video link provided by a special video content issuing site, and can also be a link of a video report corresponding to the news content in a news web page.

In step S202, the browser client acquires a platform identification (ID) code of the mobile terminal, the platform ID code is used for identifying the software platform of the mobile terminal.

Specifically, the platform ID code can be a version number of the software platform of the mobile terminal where the browser client locates, for example, IOS6.1.3 or Android2.3.7 and etc., which can be obtained by reading the system information in the mobile terminal. In addition, the platform ID code can also be other IDs for identifying the software platform of the mobile terminal, which is not defined herein.

In step S203, the browser client transmits a video loading request to a browser server, the video loading request including the video resource address and the platform ID code, so that the browser server delivers to the browser client a video corresponding to the video resource address and conforming to a video playback format of the software platform of the mobile terminal.

In the present embodiment, the browser client transmits to the browser server a video loading request including the video resource address acquired in step S201 and including the platform ID code acquired in step S202, to request, through the browser server, a video resource that is wished to be loaded from a corresponding video content server. Since the video loading request includes the platform ID code of the mobile terminal, and the browser server can identify the software platform of itself by using the platform ID code, thus acquiring a video resource which is suitable for being played back by the software platform of the mobile terminal, and delivering it to the browser client to load and play back. The process that the browser server requests a video resource from the video content server will be detailed in the subsequent embodiments.

In step S204, the browser client loads the video delivered by the browser server.

By step S203, what the browser server delivers to the browser client is a video resource conforming the video playback format of the software platform of the mobile terminal where the browser client locates, so the browser client can load the video resource delivered by the browser server smoothly to implement the playback and even downloading of the video resource.

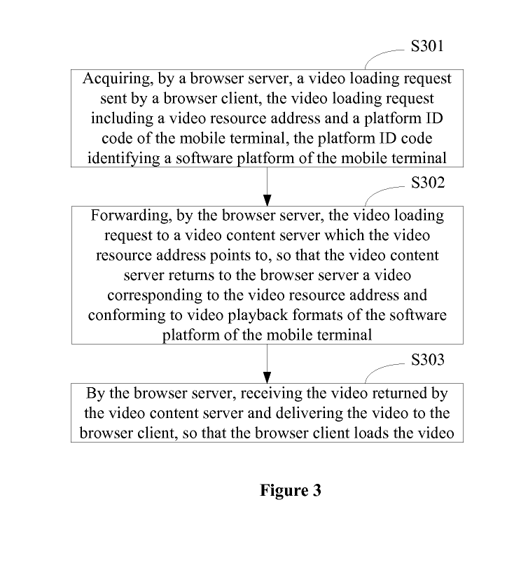

FIG. 3 shows an implementation flow diagram of the video loading method of the mobile terminal at a browser server according to the embodiment of the present application.

In step S301, the browser server acquires a video loading request transmitted by the browser client. The video loading request includes the video resource address and the platform ID code of the mobile terminal, and the platform ID code is used for identifying the software platform of the mobile terminal.

Corresponding to the above mentioned step S201 to step S203, in the video loading request transmitted by the browser client and obtained by the browser server, the carried video resource address is acquired by the browser client from the currently accessed web page, and the carried platform ID code is acquired by the browser client from the system information of the mobile terminal, and is used for identifying the platform ID code of the software platform of the mobile terminal.

In step S302, the browser server forwards the video loading request to a video content server which the video resource address points to, so that the video content server returns to the browser server a video corresponding to the video resource address and conforming to a video playback format of the software platform of the mobile terminal.

The video resource address not only represents the storage path of the video resource in the network, but also simultaneously can determine the video content server which the video resource address points to based on the host name in the video resource address.

In the present embodiment, the browser server needs to request a corresponding video resource from the video content server which the video resource address in the loading request points to, therefore by directly forwarding to the video content server the video loading request sent by the browser client, the browser server can take the platform ID code carried in the video loading request as the platform ID code of itself, so that the video format of the video returned by the video content server complies to the video format that can be played back by the software platform of the mobile terminal.

The specific implementation that the video content server returns a corresponding video based on the video loading request will be detailed in the subsequent embodiments, and will not be repeated herein.

In step S303, the browser server receives the video returned by the video content server and delivers the video to the browser client, so that the browser client loads the video.

Through step S302, in step S303, the video received by the browser server must be the video that can be played back by the software platform of the mobile terminal where the browser client transmitting the video loading request locates. Therefore, the browser server can allows the browser client to load and play back the video successfully or even download the video by delivering the video returned by the video content server to the browser client.

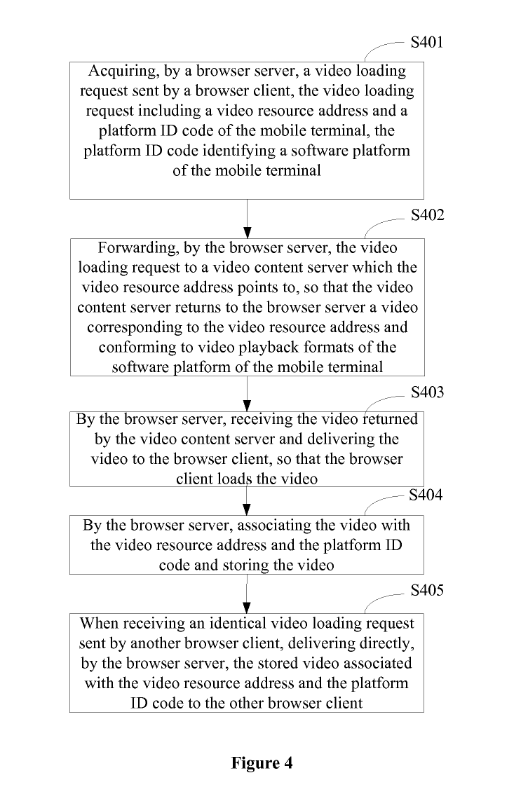

FIG. 4 is an implementation flow diagram of a video loading method of a mobile terminal at a browser server according to another embodiment of the present application.

As an embodiment of the present application, as shown in FIG. 4, steps S401-S403 are the same with steps S301-S303 in FIG. 3, and are not repeated herein.

In step S403, after the browser server delivers the video returned by the video content server to the browser client, the method further comprises:

In step S404, the browser server associates the video with the video resource address and the platform ID code and stores the video.

In the present embodiment, the browser server does not purely forward the video returned by the video content server to the browser client, but it also prestores the video in the preset database of itself after associating the video with the video resource address and the platform ID code.

In step S405, when receiving an identical video loading request sent by another browser client, the browser server transmits directly the stored video associated with the video resource address and the platform ID code down to the other browser client.

After prestoring the video in step S404, once receiving an identical video loading request sent by another browser client of the browser server later or after the same browser client has sent a repeated identical video loading request, the browser server does not need to repeat the step of requesting a video resource from the video content server, but directly queries in the preset database whether there is a video associated with the video resource address and platform ID code carried in the video loading request. When there is the video, it is sufficient that the browser server directly delivers the video to the browser client transmitting the video loading request.

Through the present embodiment, the efficiency with which the browser client requests to load a video will be greatly enhanced.

It can be readily conceived that, under the content providing scheme in which video resources from various sites are centrally exhibited by the browser server in a preset page of the browser client, if the software and hardware processing ability of the browser server is enough, then in the meantime that the browser server generates the preset page, it can also directly downloads all videos conforming to software platforms of all mobile terminals from a corresponding video content server to the preset database of the browser server based on the video resource address in the preset page, and associate each video with the platform ID code of the software platform of its corresponding mobile terminal and its corresponding video resource address. Thereafter, when any browser client of the browser server transmits a video loading request to the browser server, the browser server can directly return a video suitable for being played back by the software platform of the mobile terminal where the browser client locates to the browser client.

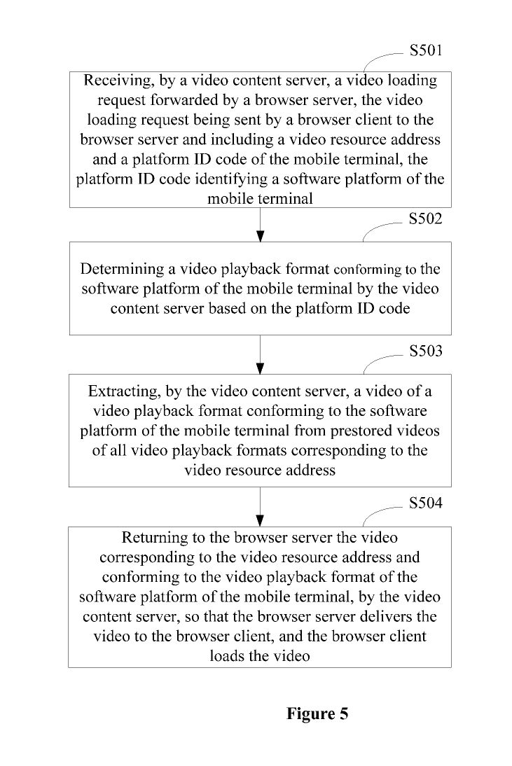

FIG. 5 shows an implementation flow diagram of a video loading method of a mobile terminal at a video content server according to the embodiment of the present application.

In step S501, a video content server receives a video loading request forwarded by a browser server. The video loading request is transmitted by a browser client to the browser server and includes a video resource address and a platform ID code of the mobile terminal. The platform ID code is used for identifying a software platform of the mobile terminal.

As described in the above mentioned embodiment, the video loading request is sent to the browser server by the browser client and is forwarded by the browser server to the video content server, and the video loading request carries the video resource address and the platform ID code of the mobile terminal which needs to play back the video.

In step S502, the video content server determines a video playback format conforming to the software platform of the mobile terminal based on the platform ID code.

Since the platform ID code identifies the software platform of the mobile terminal, the video content server can know the software platform of the mobile terminal that needs to play back the video by reading the platform ID code carried by the video loading request, thereby determines the video playback format supported by the software platform of the mobile terminal.

In step S503, the video content server extracts a video of the video playback format conforming to the software platform of the mobile terminal from prestored videos of all video playback formats corresponding to the video resource address.

As the issuer of the video resource, the video resource requested by the mobile terminal is prestored in the video content server, and in order to conform to the playback demands of different mobile terminals, for each kind of video resource, versions of different video playback formats are stored in the video content server. In the present embodiment, based on the video resource address in the video loading request, the video content server can address to the specific position storing the video resource requested by the mobile terminal. In the meantime, based on the video playback format compatible with the mobile terminal requesting the video resource, determined in step S502, the video content server extracts the video conforming to the video playback format of the software platform of the mobile terminal.

In step S504, the video content server returns to the browser server the extracted video so that the browser server delivers the video down to the browser client, and the browser client loads the video.

Thereby, the video content server returns to the browser server the video of a correct video playback format so that the browser server can deliver the video to the browser client, which loads and plays back or even download the video successfully.

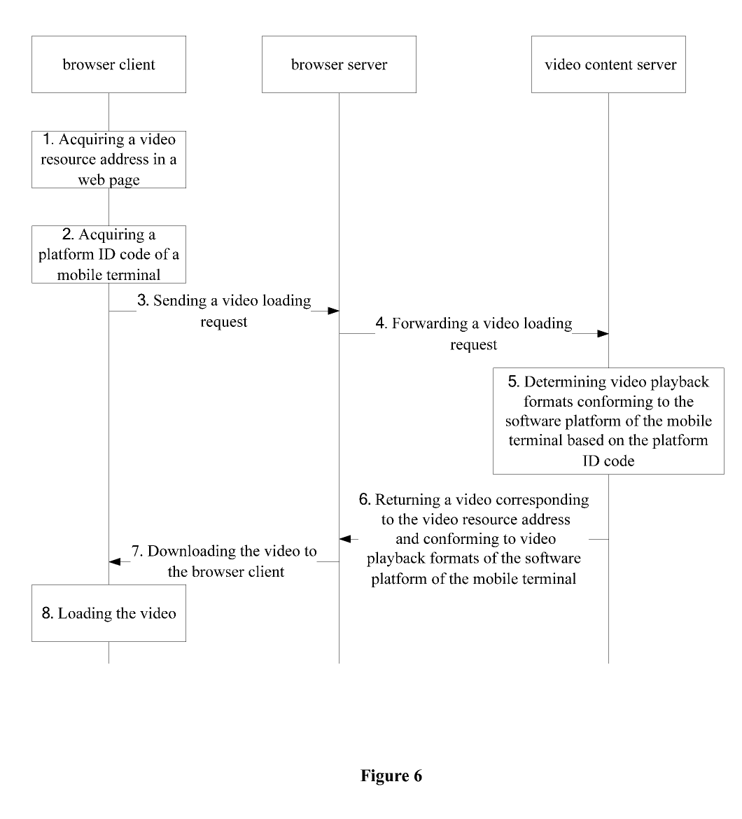

FIG. 6 shows an interactive flow diagram of a video loading method of a mobile terminal according to an embodiment of the present application, which is detailed as follows.

1. The browser client acquires a video resource address in a web page.

2. The browser client acquires a platform ID code of a mobile terminal.

3. The browser client transmits a video loading request including the video resource address and the platform ID code to the browser server.

4. The browser server forwards a video loading request to the video content server which the video resource address points to.

5. The browser server determines a video playback format conforming to the software platform of the mobile terminal based on the platform ID code.

6. The video content server returns to the browser server a video corresponding to the video resource address and conforming to the video playback format of the software platform of the mobile terminal.

7. The browser server delivers the video to the browser client.

8. The browser client loads the video.

The embodiment of the present application is based on a content providing scheme that a browser server centrally exhibits resources from various sites in a preset page of a browser client. With respect to the scheme, a video loading method of a mobile terminal is provided, so that when the browser server are exhibiting video resources to the browser client based on the scheme, the browser client can successively request, from a video content server through the browser server, a video suitable for being played back by the software platform of the mobile terminal it is located in, thereby increasing the ability of dissemination of the video resources.

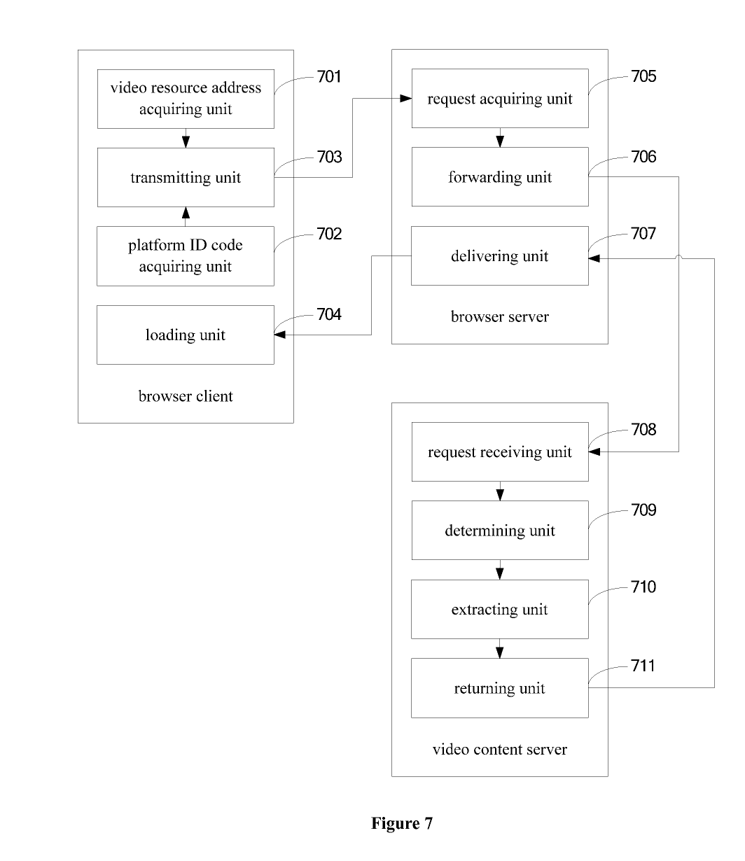

FIG. 7 shows a device structural diagram of a video loading system of a mobile terminal according to an embodiment of the present application. To facilitate the description, only the portions related to the present embodiment are shown.

The video loading system of the mobile terminal shown in FIG. 7 includes a browser client, a browser server and a browser server.

The browser client comprises a video resource address acquiring unit 701, a platform ID code acquiring unit 702, a transmitting unit 703 and a loading unit 704.

The video resource address acquiring unit 701 acquires a video resource address in a web page.

The platform ID code acquiring unit 702 acquires the platform ID code of the mobile terminal, the platform ID code is used for identifying a software platform of the mobile terminal.

The transmitting unit 703 transmits a video loading request to the browser server, the video loading request includes the video resource address and the platform ID code, so that the browser server delivers to the browser client a video corresponding to the video resource address and conforming to a video playback format of the software platform of the mobile terminal.

The loading unit 704 loads the video delivered by the browser server.

The browser server comprises a request acquiring unit 705, a forwarding unit 706, and a delivering unit 707.

The request acquiring unit 705 acquires a video loading request transmitted by a browser client. The video loading request includes a video resource address and a platform ID code of the mobile terminal, the platform ID code identifies a software platform of the mobile terminal.

The forwarding unit 706 forwards the video loading request to a video content server which the video resource address points to, so that the video content server returns to the browser server a video corresponding to the video resource address and conforming to the video playback format of the software platform of the mobile terminal.

The delivering unit 707 receives the video returned by the video content server and delivers the video to the browser client, so that the browser client loads the video.

Optionally, the browser server further includes a storage unit which associates the video with the video resource address and the platform ID code and stores the video.

The delivering unit 707 is further configured to, when receiving an identical video loading request transmitted by another browser client, deliver directly, by the browser server, the stored video associated with the video resource address and the platform ID code to the other browser client.

The video content server comprises a request receiving unit 708, a determining unit 709, a extracting unit 710 and a returning unit 711.

The request receiving unit 708 receives a video loading request forwarded by a browser server. The video loading request is transmitted by a browser client to the browser server and includes a video resource address and a platform ID code of the mobile terminal, the platform ID code is used for identifying a software platform of the mobile terminal.

The determining unit 709 determines a video playback format of the software platform of the mobile terminal based on the platform ID code in the video loading request received by the request receiving unit 708.

The extracting unit 710 extracts a video of the video playback format conforming to the software platform of the mobile terminal determined by the determining unit 709 from prestored videos of all video playback formats corresponding to the video resource address.

The returning unit 711 returns to the browser server the extracted video extracted by the extracting unit 710, so that the browser server delivers the video to the browser client, and the browser client loads the video.

The embodiment of the present application is based on a content providing scheme that a browser server centrally exhibits resources from various sites in a preset page of a browser client. With respect to the scheme, a video loading method of a mobile terminal is provided, so that when the browser server is exhibiting video resources to the browser client based on the scheme, the browser client can successively request, from a video content server through the browser server, a video suitable for being played back by the software platform of the mobile terminal it is located in, thereby increasing the ability of dissemination of the video resources.

What is described above is only the preferred embodiments of the present application, instead of limiting the present application, any modification, equivalent substitution and improvement made within the spirit and principle of the present application are contained in the protection scope of the present application.

1. A method for loading a video at a mobile terminal, the method comprising:
acquiring by a browser client a video resource address from a web page;
acquiring a platform ID code of the mobile terminal by the browser client, the platform ID code identifying a software platform of the mobile terminal;
transmitting to a browser server a video loading request including the video resource address and the platform ID code by the browser client, so that the browser server delivers to the browser client a video corresponding to the video resource address and conforming to a video playback format of the software platform of the mobile terminal; and
loading, by the browser client, the video delivered by the browser server.

2. The method of claim 1, the method further comprising:
acquiring, by a browser server, a video loading request sent by a browser client;
forwarding, by the browser server, the video loading request to a video content server which the video resource address points to, so that the video content server returns to the browser server a video corresponding to the video resource address and conforming to a video playback format of the software platform of the mobile terminal; and
by the browser server, receiving the video returned by the video content server and delivering the video to the browser client.

3. The method of claim 2, the method further comprising:
receiving, by a video content server, a video loading request forwarded by a browser server;
determining a video playback format conforming to the software platform of the mobile terminal by the video content server based on the platform ID code;
extracting, by the video content server, a video of the video playback format conforming to the software platform of the mobile terminal from prestored videos of all video playback formats corresponding to the video resource address;
returning to the browser server the extracted video by the video content server.

4. The method of claim 3, the method further comprising:
the browser server, associating the video with the video resource address and the platform ID code and storing the video.

5. The method of claim 4, the method further comprising:
when receiving an identical video loading request sent by another browser client, or when receiving a repeated identical video loading request sent by the same browser client, the browser server does not repeat the step of requesting a video resource from the video content server, but directly delivers the stored video associated with the video resource address and the platform ID code to the browser client.

6. The method of claim 5, wherein, the browser client runs on the mobile terminal.

7. The method of claim 6, the method further comprising: extracting and integrating by the browser server the video resources provided by the video content server so as to generate the web page which centrally exhibits the video resources.

8. The method of claim 7, the method further comprising: presenting by the browser client the web page to a user of the mobile terminal.

9. A video loading apparatus, the apparatus comprising a browser server, the browser server, including:
a request acquiring unit configured to acquire a video loading request sent by a browser client;
a forwarding unit configured to forward the video loading request to a video content server which the video resource address points to, so that the video content server returns to the browser server a video corresponding to the video resource address and conforming to a video playback format of the software platform of the mobile terminal; and
a delivering unit configured to receive the video returned by the video content server and delivering the video to the browser client.

10. The video loading apparatus of claim 9 further comprising the browser client, wherein, the browser client includes:
a video resource address acquiring unit configured to acquire a video resource address from a web page;
a platform ID code acquiring unit configured to acquire a platform ID code of the mobile terminal, the platform ID code identifying a software platform of the mobile terminal;
a transmitting unit configured to transmit a video loading request including the video resource address and the platform ID code to a browser server, so that the browser server delivers to the browser client a video corresponding the video resource address and conforming to a video playback format of the mobile terminal; and
a loading unit configured to load the video delivered by the browser server.

11. The video loading apparatus of claim 10 further comprising the video content server, wherein the video content server includes:
a request receiving unit configured to receive a video loading request forwarded by a browser server;
a determining unit configured to determine a video playback format conforming to the software platform of the mobile terminal based on the platform ID code;
a extracting unit configured to extract a video of the video playback format conforming to the software platform of the mobile terminal from prestored videos of all video playback formats corresponding to the video resource address; and
a returning unit configured to return the extracted video to the browser server.

12. The video loading apparatus of claim 11 wherein the browser server further comprising:
a storing unit configured to associate the video with the video resource address and the platform ID code and storing the video.

13. The video loading apparatus of claim 12, wherein, in response to receiving an identical video loading request sent by another browser client, or when receiving a repeated identical video loading request sent by the same browser client, the delivering unit is further configured to determine in the storing unit if a video associated with the video resource address and platform ID code carried in the video loading request is stored in the storing unit, and in response to determining that the video is stored in the storing unit, delivering directly the stored video to the browser client.

14. The video loading apparatus of claim 13, wherein, the browser client is configured to run on the mobile terminal.

15. The video loading apparatus of claim 14, wherein, the browser server is configured to extract and integrate the video resources provided by the video content server so as to generate the web page which centrally exhibits the video resources.

16. The video loading apparatus of claim 15, wherein, the browser client is configured to present the web page to a user of the mobile terminal.

17. A method implemented by a server, the method comprising:
receiving from a mobile terminal a request for a video wherein the request includes a video resource address for the video and a platform ID code of the mobile terminal, the platform ID code identifying a software platform of the mobile terminal;
determining from the platform ID code and the video resource address if the requested video is stored at the server; and
transmitting the stored requested video to the mobile terminal.

18. The method of claim 17, further comprising:
in response to determining that the requested video is not stored at the server, transmitting a request for the video to a video content server corresponding to the video resource address.

19. The method of claim 18 further comprising:
receiving the requested video from the video content server and transmitting the requested video to the mobile terminal.

20. The method of claim 19 further comprising:
in response to receiving the requested video storing the received video at the server.
